(19) United States
(12) Patent Application Publication
(10) Pub. No.: US 2013/0007949 A1
(43) Pub. Date: Jan. 10, 2013

(54) WIRELESS ENERGY TRANSFER FOR PERSON WORN PERIPHERALS

(75) Inventors: Andre B. Kurs, Chestnut Hill, MA (US); Morris P. Kesler, Bedford, MA (US); Katherine L. Hall, Westford, MA (US); Simon Verghese, Arlington, MA (US)

(73) Assignee: WITRICITY CORPORATION, Watertown, MA (US)

(21) Appl. No.: 13/544,688

(22) Filed: Jul. 9, 2012

Related U.S. Application Data
(60) Provisional application No. 61/505,593, filed on Jul. 8, 2011.

(51) Int. Cl. A42B 3/04; H02J 17/00; A41D 1/04

(52) U.S. Cl. 2/410; 2/102; 307/104

(57) ABSTRACT

Described is a system for wireless energy transfer for person worn peripherals. The system makes use of a technique referred to as strongly-coupled magnetic resonance to transfer energy across a distance without wires and enables efficient transfer of energy over distances of 10 to 18 cm or more. The system comprises a resonant power source, which could be embedded in a person's equipment vest or backpack receiving power from a central battery pack or micro fuel cell, and a resonant power capture unit which could be integrated with the helmet or hand held weapon, electronic device, and the like that may be carried or handled by a person.

### CROSS-REFERENCE TO RELATED APPLICATIONS

This application claims the benefit of U.S. provisional patent application 61/505,593 filed Jul. 8, 2011.

### BACKGROUND

1. Field:

This disclosure relates to wireless energy transfer to person worn peripherals and apparatus to accomplish such transfer.

2. Description of the Related Art

Energy or power may be transferred wirelessly using a variety of known radiative, or far-field, and non-radiative, or near-field, techniques as detailed, for example, in commonly owned U.S. patent application Ser. No. 12/613,686 published on May 6, 2010 as US 2010/010909445 and entitled “Wireless Energy Transfer Systems,” U.S. patent application Ser. No. 12/860,375 published on Dec. 9, 2010 as 2010/0308939 and entitled “Integrated Resonator-Shield Structures,” U.S. patent application Ser. No. 13/222,915 published on Mar. 15, 2012 as 2012/0062345 and entitled “Low Resistance Electrical Conductor,” U.S. patent application Ser. No. 13/283,811 published on ______ as ______ and entitled “Multi-Resonator Wireless Energy Transfer for Lighting,” and U.S. patent application Ser. No. 13/534,966 published on ______ as ______ and entitled “Wireless Energy Transfer for Rechargeable Batteries,” the contents of which are incorporated by reference.

As advanced mobile communication, computing, and sensing devices become more essential, the burden of carrying, operating, and maintaining multiple batteries, fuel cells, and the like, increases. In both civilian and military scenarios, people are often required to carry and operate multiple electronic devices. One or more devices such as headlamps, portable computers, global positioning system devices (GPS), sensors, cameras, radios, flashlights, and the like may all be carried by a person. Each electronic device may require an energy source such as batteries, fuel cells, and the like to provide energy to each or a group of the devices. Large numbers of devices may mean a large number of batteries that may require management and/or monitoring by the user.

In systems where each device has its own energy source, i.e. batteries, the stored energy may be underutilized and may lead to significant or unnecessary extra weight that may need to be carried by the user. With each device or a group of devices having a separate energy source, the energy storage of each device may need to be large enough to power the device in the worst or maximum usage scenario, even if the device is typically used infrequently. As a result in many use scenarios, the user will be underutilizing the carried energy and perhaps carrying too much battery or stored energy capacity.

The underutilization of carried energy may be problematic for weight sensitive devices and applications. Underutilization of energy for a device attached to a helmet, for example, may mean a significant weight penalty that a user has to tolerate on their head. In many applications it is desirable to reduce or eliminate the weight attached to a person's head area since it may cause user discomfort, fatigue, or neck problems.

One way to reduce the burden of multiple batteries and improve their utilization is to use wearable battery packs and/or central energy generators that can provide power to various peripheral devices that are attached to or carried by a person. With one or several central batteries the potable energy may be shared and distributed to the devices that need the power. However, such devices may be tethered to the person's battery pack with cables. For devices such as headlamp, microphones, night vision goggles, and the like, that are carried on a person's head or helmet, the cables may be uncomfortable, limit movement, pose a safety risk (since cables may get snagged or caught on objects and obstacles), and reduce the reliability of the system.

Thus what is needed is a better way for energy distribution for person worn peripheral devices.

### SUMMARY

Wireless energy transfer can enable such peripheral devices to be powered from a wearable battery pack or portable power generator, without the safety and ergonomic drawbacks of multiple wired connections that tether the mobile electronic devices, such as a head worn device or helmet to the user.

In one aspect, a system for wireless energy transfer includes a person worn central energy source. The energy source may be used to provide power to one or more wireless power source resonators that generate an oscillating magnetic field. The oscillating magnetic field may be used to transfer energy wirelessly to wireless power repeaters and/or devices worn by a person or carried by a person. The energy source may be a rechargeable battery. To generate electricity from the oscillating magnetic fields the system may include one or more device resonators that are configured to interact with the oscillating magnetic fields and generate an electric current. The device resonator may be helmet mounted and the source resonator may be mounted on the person's body.

In another aspect the power output or the frequency of the person worn source resonators may be adjusted depending on the type of tissue that is in proximity or interacts with the magnetic fields of the source resonator. The system may further include field shaping structures comprising magnetic materials and/or conducting materials, to reduce the interaction of the magnetic fields with the person's tissue and body parts.

In another aspect a person worn wireless energy transfer system may include a rechargeable battery and a source resonator configured to receive electrical energy from the battery and generate an oscillating magnetic field. A device resonator configured and positioned to interact with the oscillating magnetic fields may be positioned or attached to a person's helmet to transfer energy wirelessly to electronic devices mounted to the helmet or near the helmet from the rechargeable battery which may be worn near or on the torso of the person. The system may include more than one source resonator and a controller that may selectively energized each of the source resonators. The source resonators may be spaced or positioned to enable wireless energy transfer from the body of a person to the device resonator on the helmet even if the person moves, rotates, or tilts their head. The source resonators that provide the best coupling to the device resonator on the helmet may be energized depending on the rotation of the helmet. In another aspect the system may include more than one device resonator, the resonators may be positioned such that at least one resonator has good coupling to the source resonator despite any head rotations of the person wearing the helmet.

### BRIEF DESCRIPTION OF FIGURES

FIG. 1 is a diagram of an embodiment of system for wireless energy transfer to a helmet.

FIG. 2A is a diagram showing vertically aligned dipole structures and FIG. 2B is a diagram showing horizontally aligned dipole structures.

FIG. 3 is a diagram of two resonators comprising a conductor wrapped around a block of magnetic material.

FIG. 4 is a diagram of an embodiment of a system for wireless energy transfer to a helmet.

FIG. 5 is a graph showing energy transfer efficiency as a function of azimuth angle for a helmet wireless energy transfer system.

FIG. 6 is a graph showing energy transfer efficiency as a function of coil separation for a helmet wireless energy transfer system.

FIG. 7 is a diagram of an embodiment of a system for wireless energy transfer to a helmet using multiple source and device resonators.

FIG. 8 is a diagram of an embodiment of a system for wireless energy transfer to glasses using a shoulder mounted source resonator.

### DETAILED DESCRIPTION

A wireless energy transfer system may be used to wirelessly transfer energy from one or more central batteries and/or fuel cells and/or solar panels and/or other types of energy packs worn on a vest, backpack, harness, shirt, pant, belt, coat, or any type of clothing and the like, to a head worn or helmet mounted electric or electronic device. The wireless energy transfer system may use strongly-coupled magnetic resonators. The resonators may have a high quality factor Q>100. The two resonators exchanging energy by have sqrt(Q1Q2)>100. The system comprises at least one wireless energy source resonator, which might be embedded or attached to the user's equipment, clothing, vest, backpack and the like. The source resonator generates an oscillating magnetic field which may be received by one or more energy capture device resonators which may be integrated with the helmet or device. In embodiments 5 watts or more of power may be transferred across a gap of 10 cm or 18 cm or more from a source resonator to a device resonator. In embodiments, repeaters may be used in the wireless energy transfer system.

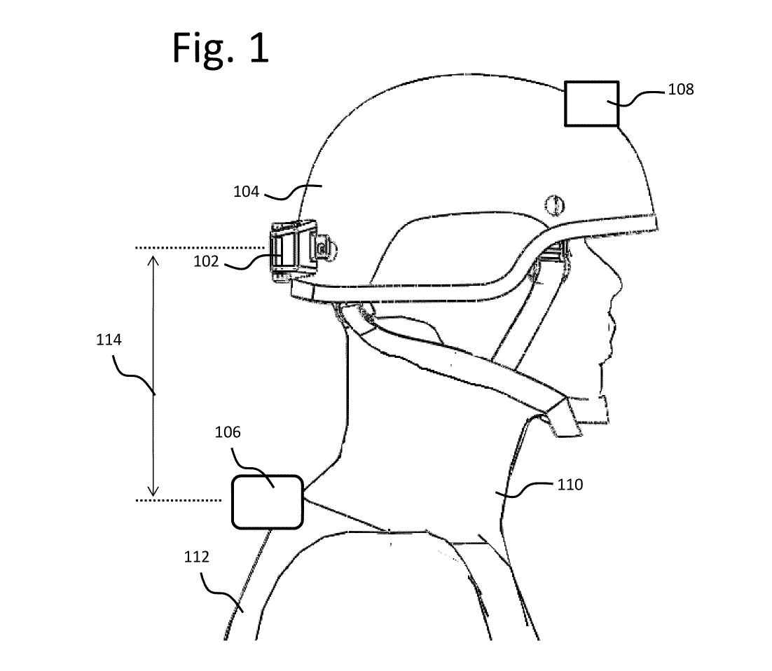

An example embodiment showing one configuration of the system is shown in FIG. 1. In the exemplary embodiment, energy is transferred wirelessly to an energy capture device resonator 102 mounted on the back of a helmet 104 from a source resonator 106 mounted on a vest 112 of a person 110. The source resonator 106 may be energized by a battery (not shown) carried by the person 110. The source resonator 106 generates an oscillating magnetic field that induces an electric current in the energy capture device resonator 102. The electrical energy induced in the device resonator 102 may be used to energize electric or electronic devices 108 mounted or attached to the helmet 104. Thus energy is transferred wirelessly across a gap 114 to power devices 108 on a person's head without cables between the device and the main battery carried by the person 110.

The wireless energy transfer is based on carefully designed, high quality magnetic resonators, strongly coupled to other magnetic resonators, so that electric power is selectively and efficiently transferred from one resonator to another, via a magnetic field, with very little power lost or dissipated to other near-by off-resonant or non-resonant objects. In the system it may be necessary to ensure energy transfer during changes in resonator positioning or movement due to the movement of a person's head, changes in the mounting of the resonators and the like.

In embodiments the system may use any number of resonators and resonator structures. A large number of suitable resonator structures have been described in U.S. patent application Ser. No. 12/789,611 Published as US Publication Number 2010/0237709A1 on Sep. 23, 2010. For example, the so called planar resonator structures comprising an electrical conductor wrapped around a block of magnetic material or various configurations may be used. Likewise many different forms of capacitively loaded loop resonators with or without shielding may be employed. In embodiments the types of resonators chosen, their orientation, size and the like may depend on the details of the application and the desired offset tolerance, size limits, power transfer efficiency, target weight specifications and the like.

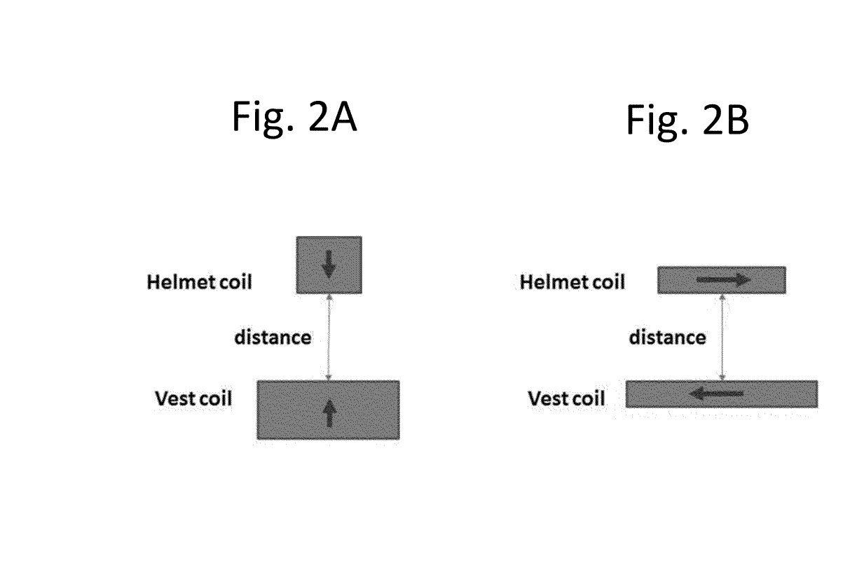

In embodiments various coil configurations with different dipole moments and orientations may be effective for person mounted (e.g. vest) to helmet energy transfer. In embodiments the resonators may be oriented with two different dipole moment orientations and configurations. FIG. 2A and FIG. 2B show two different dipole orientations of resonators, vertically aligned, and horizontally aligned. FIG. 2A shows a configuration with vertically aligned dipole moments. FIG. 2B shows a configuration with horizontally aligned dipole moments. The benefit of the parallel or horizontally aligned configuration is that both ends of the magnetic dipole resonator on the vest can couple to the helmet resonator. The parallel configuration may also have an advantage in its size, shape, and weight. In an exemplary environment, a coupling coefficient of k=0.02 was achieved with a helmet-resonator weight of 0.17 kg and a vest-resonator weight of 1.1 kg. Also, the shape of each resonator may be more suitable for integration with both the helmet and the vest than the vertical configuration.

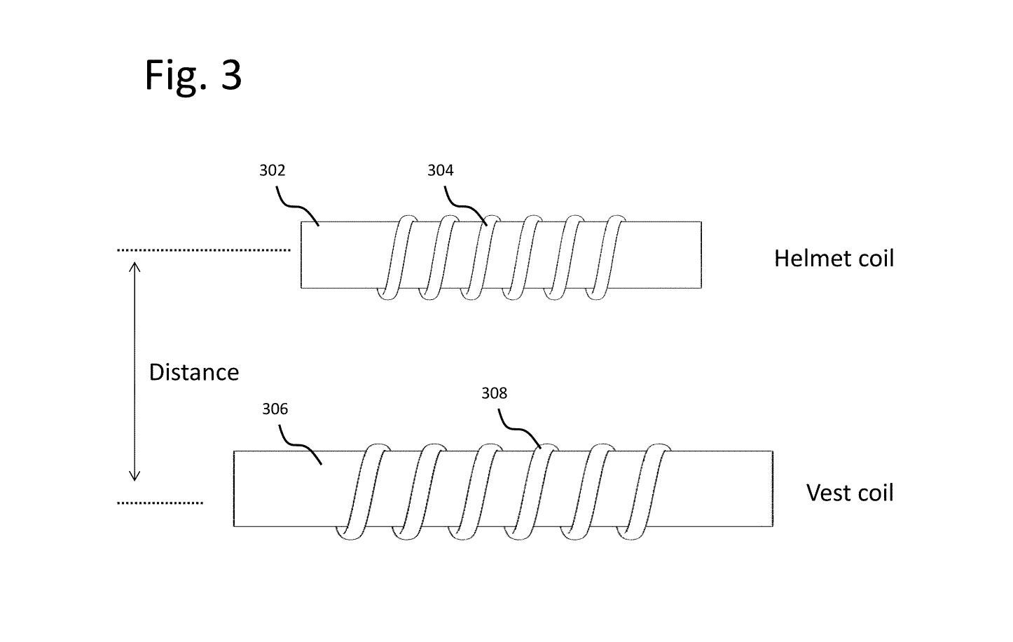

To ensure adequate energy transfer from a source resonator on the body to a device resonator on the head and/or helmet, over a range of resonator offsets and distances with a constraint on size and weight of the resonators, the resonators may preferably be oriented with horizontally aligned dipole moments. Resonators with horizontally aligned dipole moments may be a variant of the so called planar resonator structures. An embodiment of the system with planar resonator structures is shown in FIG. 3. The helmet mounted device resonator coil (Helmet coil) and the vest mounted source resonator coil (vest coil) both comprise a conductor 304, 308 wrapped around a block or core of magnetic material 302, 306. In this configuration the two resonators have their dipole moments in the horizontal direction or parallel to one another.

An example embodiment comprising horizontally aligned resonators was used to demonstrate the feasibility and performance of the system. In the example embodiment, the energy capture device resonator mounted on the helmet comprises 10 turns of 1054/44 AWG Litz wire wound around 160 g of 3F3 ferrite material and has a Q>200. The vest-mounted resonator contains 215 g of ferrite encased in a polymer sleeve that is wound with 10 turns of the same type of Litz wire to form planar type resonators similar to that shown in FIG. 3 and has a Q>200.

A lithium ion battery back worn in the vest of the user is used as the power source for the electronics board that houses the power and control circuitry for the source resonator. The helmet-mounted resonator is connected to a small device board with a rectifier and output voltage regulator. The output regulator was set for 5 Vdc and connected to a LED headlamp for demonstration purposes.

The ferrite material used for both the helmet and vest resonators consists of small rectangular tiles that were stacked to make resonators in a parallel-piped shape. Shaped resonators may be fabricated that conform to the natural contours of both the helmet and the vest. This could be accomplished either by grinding angled faces on the individual tiles or by sintering magnetic powder in a custom mold.

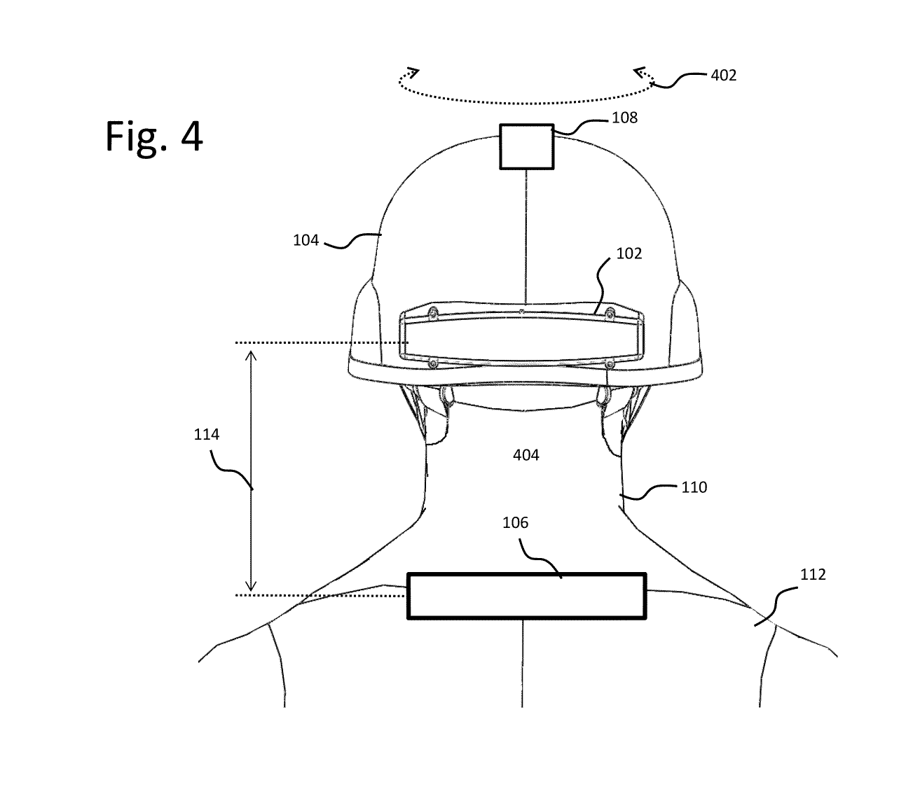

FIG. 4 shows the experimental configuration used to measure the efficiency and power as a function of head position. The source resonator 106 was mounted on the vest 112 worn by the person 110. The device or energy capture resonator 102 was mounted on the back of a helmet 104. The energy captured by the device resonator was used to power a headlamp 108 on the helmet via a wire. The separation distance 114 as well as the azimuth angle or the head rotation angle 402 was modified while parameters of the wireless energy transfer were measured.

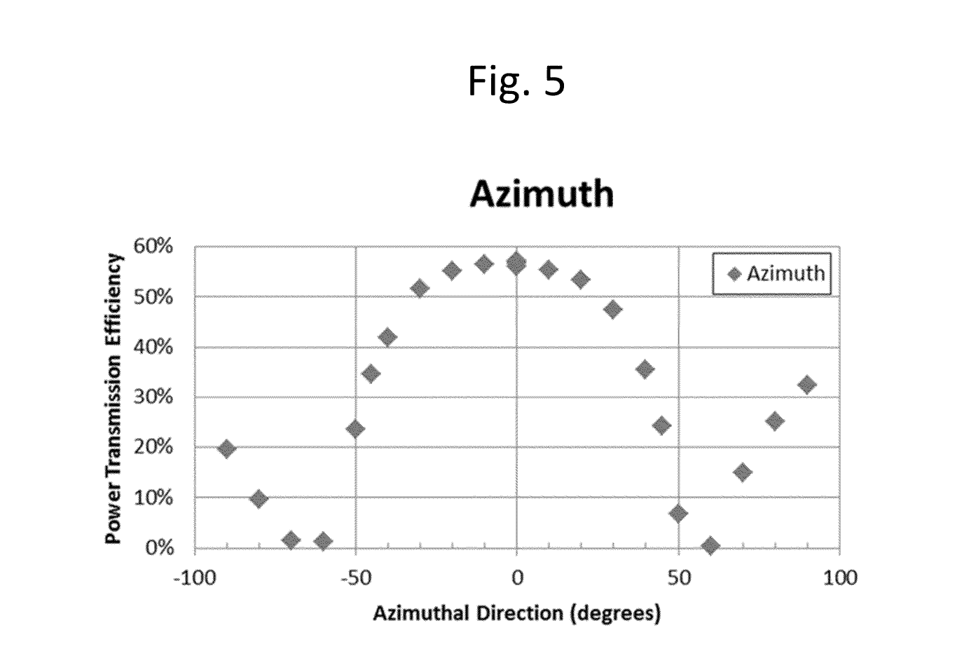

The efficiency of energy transfer as a function of the azimuth rotation for 12 cm separation distance between the source and device resonators is shown in FIG. 5. When the resonators are aligned the efficiency of energy transfer reaches almost 60%. A null in the coupling coefficient occurs when the head swivels approximately 60 degrees in azimuth and is manifested as a drop in efficiency of energy transfer in the figure. The null may be extended or moved to larger angles by enlarging the resonators along their dipole moments.

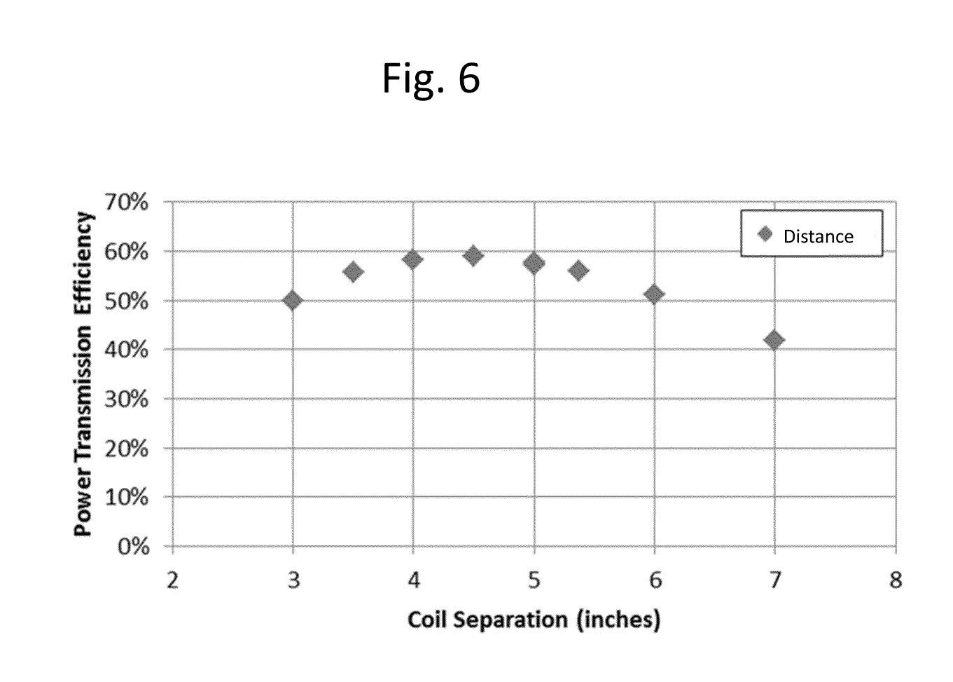

The efficiency of energy transfer as a function of the separation distance between the source and device resonators is shown in FIG. 6. The graph shows that even though the resonators were tuned for a fixed distance of 12 cm the efficiency of energy transfer remain above 50% for the variation of separation distance of 7.5 cm to 15 cm.

In embodiments the captured energy may be used to power any number of devices, sensors, electronics, communication equipment and the like on or around the head or on the helmet. The electrical energy from the device resonator may be used directly as AC current or may be conditioned or rectified to provide DC current. In embodiments the system may include a small energy storage element on the helmet or on the head that is charged from the energy captured by the device resonator. The energy storage may be a rechargeable battery or a super capacitor that may be used to provide energy to the devices in cases when the wireless energy transfer gets interrupted. For example if the user rotates his head to reach the null point in the resonator coupling the wireless energy transfer may be interrupted. During this time power delivery to the electronics may be continued by using energy in the small battery or super capacitor. The energy storage element may be sized according to the expected or maximum time of wireless energy interruption for a specific use scenario. For example, use studies may be conducted to examine the frequency and amount of time that a user may turn his head to an area where the wireless energy transfer is no longer effective. The energy storage element may be sized only to provide energy to the devices during those times and recharge when wireless energy transfer is again possible. The energy storage element may therefore be small or light weight compared to a battery that is expected to power the devices continuously.

In other embodiments the source resonators and the device resonators may be configured to reduce or eliminate dead spots within the range of the person's head mobility. In one exemplary embodiment, multiple source resonators may be used as wireless energy sources. The multiple source resonators may be selectively driven depending on the rotation of the head. The source resonator with the strongest coupling may only be activated or some or all of the source resonators may be driven with oscillating currents with different phase or amplitude to steer the magnetic fields.

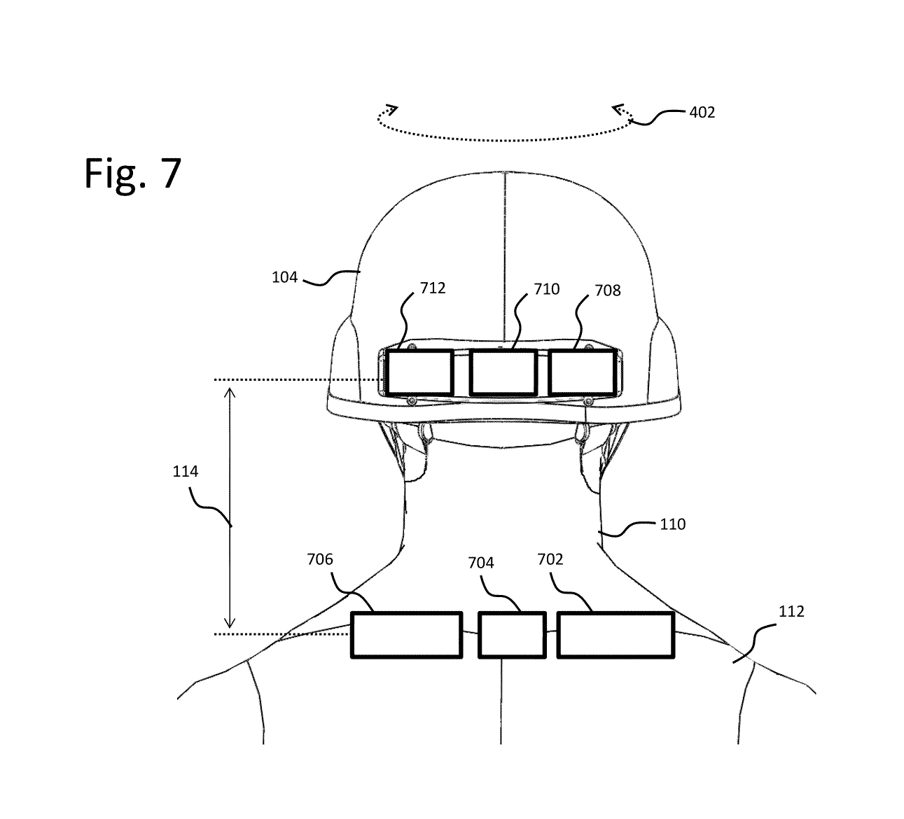

In one exemplary embodiment, multiple device resonators 712,710,708 may be used to capture the energy from one or more source resonators 706, 704, 702 as depicted in FIG. 7. The multiple device resonators may be selectively activated depending on the rotation 402 of the head. Only the device resonator with the strongest coupling to the source may be activated or all three or more device resonators may be activated and their captured electrical energy combined to charge a battery or power an electronic device. The system may include a controller to measure the efficiency of energy transfer and electrical characteristics of the energy transfer between the sources and devices. By measuring the voltage and current on the source resonators and voltage and current on the device resonators the controller may actively choose to energize some or all of the sources depending on the measurements.

In embodiments the device or source resonator may be used to charge batteries from an external wireless energy source. The source resonator worn by the person may normally be used to transfer energy to the helmet but may be configurable to also capture energy from an external source allowing the resonator to wirelessly recharge the central person worn battery. The source resonator worn by the person may be configured to become a device resonator. The electronics may be configurable from a source amplifier functionality to rectifier and battery charger functionality. External source resonators may be mounted inside vehicles, on the back of seats, beds, and other structures providing wireless energy to the resonator mounted on the person when the person is sitting in the vehicle, resting in a bed, and the like.

In embodiments source resonators may be located on the shoulders, back, front, neck, chest, stomach, hips, buttocks, thighs, hands, feet, and arms of the person. Device resonators capable of capturing the energy may be positioned on the sides, back, top and the like of the helmet, head, and head-worn devices. The device resonators may be positioned on the outside of the helmet or may be configured to cover the inside of the helmet protecting it from external abrasions and damage.

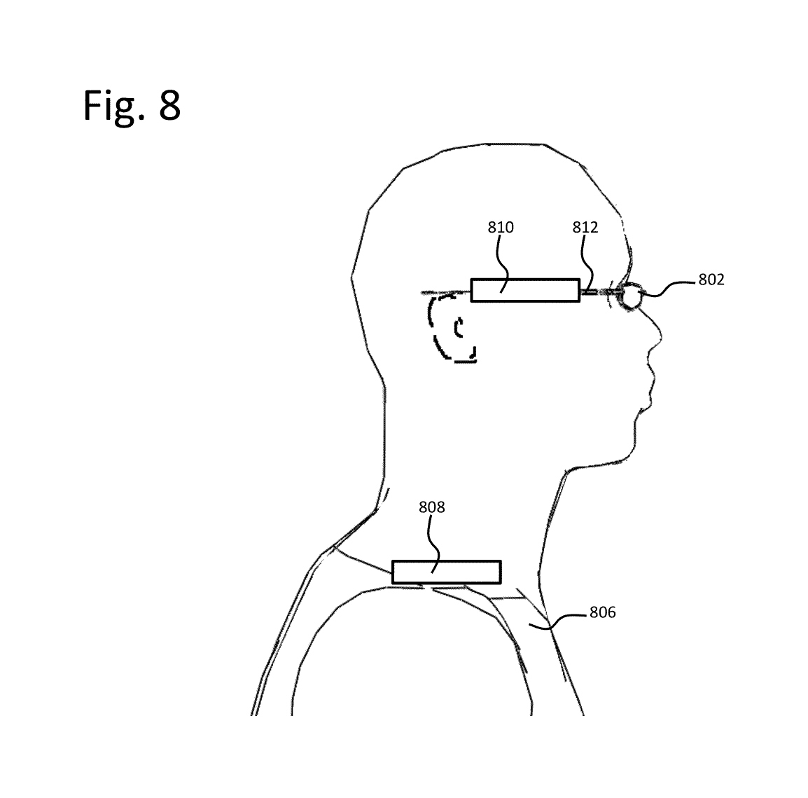

Although the example embodiment demonstrated the use of a wireless energy transfer system from a vest to a helmet, it should be understood that other configurations are within the scope of this design. Energy may be transferred from a person to any number of peripherals that may be carried, or attached to a person. For example energy may be transferred to glasses, heads up displays, portable monitors and the like. An example embodiment for wireless energy transfer to a glasses mounted heads up display is shown in FIG. 8. The heads up display may have a device resonator 810 mounted on the side or the temple area 812 of the glasses 802. The source resonator 808 may be worn on the shoulder area of the person. The source resonator 808 may be energized from a person worn battery that may be carried on the back or side of the person eliminating a heavy battery or energy storage element from the glasses.

In other embodiments energy may be transferred from a vest to a device carried by the user such as a weapon, computer, tool, and the like. Energy may be transferred from the legs to shoes that may be integrated with sensors for monitoring the persons' foot health, or overall fitness and stability by measuring stride length, pressure, movement and the like.

Likewise, although the exemplary embodiment was described using a military helmet those skilled in the art will appreciate that the design may be configured for any helmet or any head mounted structure for recreational, industrial, and other uses. For example, wireless energy transfer may be used for motorcycle helmets to power radios, lights, and instruments inside the helmet. In another example wireless energy transfer may be used in bicycle helmets to transfer energy from a backpack to a helmet fitted with lights. In another example, wireless energy transfer may be used for hard hats to power lights, radios, sensors, glasses and the like.

In embodiments wireless energy transfer for person worn peripherals, a system may include a separate device resonator for each electronic device. Having an independent resonator for each device may allow simpler power control. Each device may be able to control its resonator and detune the resonator from the resonant frequency of the source if it is off or not requiring power. In some embodiments the device resonators may be imbedded in the devices requiring power. In other embodiments a single source resonator may power many device resonators.

In other embodiments the device resonators may be separate from the devices. The device resonator may be located separately from the device requiring power. The energy captured by the device resonator may be transferred to the device via conductor wire. A separate wired device resonator may be placed away from the device in a location closer to a source resonator or in a location that is less obtrusive to the user. For example, in the helmet embodiment shown in FIG. 1, the device resonator 102 is located at a distance away from the headlamp 108 and energy is transferred to the headlamp from the device resonator via a wire (not shown). In this embodiment the device resonator was positioned to reduce inconvenience and obstruction to the user.

In some embodiments a single device resonator may deliver power to more than one electronic device. In embodiments energy transfer may be divided into regions or subsystems. For example, wireless energy transfer may be used to span moving human parts or areas where wires are cumbersome or ineffective and once transferred wirelessly may be distributed in a traditional means using electrical conductors such as wires, printed circuit board (PCB) traces, conductive textiles, and the like. For example, a helmet may be such a subsystem. A single device resonator may wirelessly receive energy and distribute the energy to multiple devices on the helmet or near the helmet using wires. Other such systems may include hands, shoes, feet, arms, and the like. In embodiments a subsystem may include more than one device resonator that may receive wireless energy from more than one source resonator and distribute the energy over one or more devices in the subsystem.

In embodiments the device resonators may be embedded in the batteries or the battery packs of the devices. The batteries of devices may be configured for wireless energy transfer allowing the batteries to be recharged when within range of a wireless energy source. For example, sample designs of wireless power enabled batteries are described in U.S. patent application Ser. No. 13/534,966 published on ______ as ______ and entitled “Wireless Energy Transfer for Rechargeable Batteries,” the contents of which are incorporated by reference.

In embodiments the person worn energy transfer system may include safety precautions. The oscillating magnetic fields may cause localized tissue heating or induced currents in some types of tissues. Depending on the location and orientation of the resonators it may be important to limit the power output of the source resonators or the magnitude of the magnetic fields reaching the body tissue or the nervous system of the user. In the example system shown in FIG. 4, five watts was safely transferred to the device resonators while meeting all safety limits despite being close to the spinal cord and nervous system tissue of the user. To meet safety limits it may be preferable to operate the resonators at resonant frequencies at higher frequencies of 150 kHz or more. In some embodiments resonant frequencies and the frequencies of the generated magnetic fields may be 1 MHz or more.

In embodiments the system may include shielding material around high power (10 W or more) source of device resonators to limit or reduce the interactions of the magnetic fields used for energy transfer with the person's body parts. The shielding may comprise a good electrical conductor. The electrical conductor shield may be positioned against a portion of the user's body such that the magnetic fields of the source are deflected away from that portion of the user's body. In embodiments the shield may comprise a flexible electrical conductor. The conductor may be a thin sheet of copper or an electrically conductive textile for example.

Going back to the example embodiment of wireless energy transfer to a helmet as shown in FIG. 4, the system may include a shield to reduce the interactions of the fields with the back of the neck, spice, and head. In embodiments that may require higher power transfer, 10 W or 20 W or more the system may include a flexible or rigid flap that covers the neck area 404 of the user. The flap may comprise a conductive material that shields the neck and spinal cord from the magnetic fields. The flap map be part of the helmet or part of the headwear of the user. In embodiments the shield may be part of the collar of the user's clothing.

While the invention has been described in connection with certain preferred embodiments, other embodiments will be understood by one of ordinary skill in the art and are intended to fall within the scope of this disclosure, which is to be interpreted in the broadest sense allowable by law. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A system for wireless energy transfer for peripherals comprising:
a wearable energy source; and
at least one wearable source resonator configured to be worn by a wearer and configured to receive electrical energy from the energy source and to generate an oscillating magnetic field to transfer energy wirelessly to at least one of a wearable electronic device and a devices in proximity the wearer

2. The system of claim 1, wherein the energy source is a rechargeable battery.

3. The system of claim 1, further comprising at least one device resonator configured and positioned to interact with the oscillating magnetic field of the at least one source resonator and to generate electrical energy.

4. The system of claim 3, wherein the electrical energy from the at least one device resonator is used to power at least one wearable electronic device.

5. The system of claim 3, wherein the at least one device resonator is mounted on a helmet.

6. The system of claim 5, wherein the at least one wearable source resonator is mounted on a vest.

7. The system of claim 6, wherein the system comprises a shield comprising an electrical conductor that is positioned to reduce the interactions of the magnetic fields with the wearer's body.

8. The system of claim 6, wherein the power output of the source resonator is controlled to limit the magnitude of the magnetic fields that interact with the wearer's body.

9. The system of claim 8, wherein the frequency of the source resonator is controlled to adjust the frequency of the magnetic fields that interact with the wearer's body.

10. The system of claim 8, wherein the power output of the source resonator is adjusted depending on the type of tissue in proximity to the source.

11. The system of claim 1, wherein the source resonator is configured to capture energy from an external source and recharge the energy source.

12. A helmet-based system for wireless energy transfer for peripherals, the system comprising:
a wearable rechargeable battery;
a helmet;
a wearable source resonator, configured to receive electrical energy from the battery and generate an oscillating magnetic field; and
a device resonator mounted to the helmet and configured and positioned to interact with the oscillating magnetic field of the source resonator and to generate electrical energy.

13. The system of claim 12, wherein the electrical energy generated by the device resonator is used to power at least one helmet-mounted electronic device.

14. The system of claim 12, further comprising at least one additional source resonator configured to receive electrical energy from the battery.

15. The system of claim 14, further comprising a controller, the controller configured to selectively energize one or more source resonators.

16. The system of claim 15, wherein the controller energizes the sources with the best coupling to the device resonator.

17. The system of claim 13, further comprising at least one additional device resonator, the device resonators positioned such at least one of the device resonators receives energy from the source resonator for during movement of the helmet on a person's head.
